(19) United States
(12) Patent Application Publication
(10) Pub. No.: US 2013/0247223 A1
(43) Pub. Date: Sep. 19, 2013

(54) APPARATUS AND METHOD FOR ENSURING PRIVACY IN CONTENTS SHARING SYSTEM

(71) Applicants: Korea Advanced Institute of Science and Technology, (US); SAMSUNG ELECTRONICS CO., LTD., Gyeonggi-do (KR)

(72) Inventors: Yongsuk Park, Seoul (KR); Sun-Mi Kim, Seoul (KR); Dan-Keun Sung, Daejeon (KR); Chan-Hyun Youn, Daejeon (KR); Jin-Won Kim, Seoul (KR); Ji-Young Cha, Jeju-do (KR); Tae-Hoon Kim, Daejeon (KR); Dong-Ki Kang, Daejeon (KR); Hee-Jae Kim, Daejeon (KR); Yong-Sung Park, Daejeon (KR); Young-Joo Han, Daejeon (KR)

(73) Assignees: KOREA ADVANCED INSTITUTE OF SCIENCE AND TECHNOLOGY, Daejeon (KR); SAMSUNG ELECTRONICS CO., LTD, Gyeonggi-do (KR)

(21) Appl. No.: 13/838,141

(22) Filed: Mar. 15, 2013

(30) Foreign Application Priority Data
Mar. 16, 2012 (KR) 10-2012-0027139

(51) Int. Cl. H04L 29/06

(52) U.S. Cl. CPC H04L 63/10
USPC 726/28

(57) ABSTRACT

A privacy protection policy is present in a content sharing system. A method for managing contents in a content sharing system includes receiving a content download request from a first account through a first device; and determining whether to carry out the download by considering at least one of a sharing range of a download-requested content, a content access right of the first account, a content access right of an owner account of the first device, a sharing range of a download folder, and sharing acceptance or rejection of an owner of the content.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Mar. 16, 2012, and assigned Serial No. 10-2012-0027139, the entire disclosure of which is hereby incorporated by reference.

### TECHNICAL FIELD OF THE INVENTION

The present disclosure relates generally to content sharing over a network.

### BACKGROUND OF THE INVENTION

Thanks to advances of communication technology, a smart home era for building a communication network with home appliances which provide only their independent functions and providing more convenient services over the communication network is drawing near. The smart home era is expected to utilize contents using the communication network within the home. For example, all of family members can easily share all of contents stored to not only common media devices of the family members, that is, a smart television (TV) and a Network Attached Storage (NAS) but also media devices, for example, a computer, a notebook, a tablet Personal Computer (PC), and a smart phone of the individual family member.

A device for receiving the contents can be any device in the home. Although the device of a user for enjoying the contents does not store the contents, when other device in the home stores the corresponding contents, the user can download and enjoy the contents from the other device. When the desired contents are not specified and a list of contents in the home is accessible, the user may select and enjoy one of the contents in the list.

The convenient content sharing in such a smart home era is one of main streams toward the future home culture. However, as several family members freely share the contents stored to their devices, privacy invasion is unavoidable. In this respect, what is needed is a method for ensuring the content sharing and protecting the privacy by adequately limiting the content sharing.

### SUMMARY OF THE INVENTION

To address the above-discussed deficiencies of the prior art, it is a primary aspect of the present disclosure to provide an apparatus and a method for sharing contents by considering privacy in a network.

Another aspect of the present disclosure is to provide an apparatus and a method for ensuring privacy by considering content upload and download situations in a network.

According to one aspect of the present disclosure, a method for managing contents in a content sharing system includes receiving a content download request from a first account through a first device; and determining whether to carry out the download by considering at least one of a sharing range of a download-requested content, a content access right of the first account, a content access right of an owner account of the first device, a sharing range of a download folder, and sharing acceptance or rejection of an owner of the content.

According to another aspect of the present disclosure, a method for managing contents in a content sharing system includes receiving a content upload request from a first account through a first device; and determining whether to carry out upload by considering at least one of a sharing range of an upload-requested content and a sharing range of an upload folder.

According to yet another aspect of the present disclosure, a method for managing contents in a content sharing system includes receiving a content list update request from a first account through a first device; and setting a sharing range of at least one content of a content list by considering at least one of a sharing range of at least one content of an update-requested content list and a sharing range of the at least one content of other content list.

According to still another aspect of the present disclosure, an apparatus for managing contents in a content sharing system includes a communication unit for receiving a content download request from a first account through a first device; and a control unit for determining whether to carry out download by considering at least one of a sharing range of a download-requested content, a content access right of the first account, a content access right of an owner account of the first device, a sharing range of a download folder, and sharing acceptance or rejection of an owner of the content.

According to a further aspect of the present disclosure, an apparatus for managing contents in a content sharing system includes a communication unit for receiving a content upload request from a first account through a first device; and a control unit for determining whether to carry out upload by considering at least one of a sharing range of an upload-requested content and a sharing range of an upload folder.

According to a further aspect of the present disclosure, an apparatus for managing contents in a content sharing system includes a communication unit for receiving a content list update request from a first account through a first device; and a control unit for setting a sharing range of at least one content of a content list by considering at least one of a sharing range of at least one content of an update-requested content list and a sharing range of the at least one content of other content list.

Other aspects, advantages, and salient features of the present disclosure will become apparent to those skilled in the art from the following detailed description, which, taken in conjunction with the annexed drawings, discloses exemplary embodiments of the present disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of a sharing system according to an exemplary embodiment of the present disclosure;

FIG. 2 illustrates a flowchart of a process of a central management apparatus when contents are downloaded in the sharing system according to an exemplary embodiment of the present disclosure;

FIG. 3 illustrates a flowchart of a process of the central management apparatus when contents are downloaded in the sharing system according to another exemplary embodiment of the present disclosure;

FIG. 4 illustrates a flowchart of a process of a user device when contents are downloaded in the sharing system according to an exemplary embodiment of the present disclosure;

FIG. 5 illustrates a flowchart of a process of the user device for accepting the downloaded content sharing in the sharing system according to an exemplary embodiment of the present disclosure;

FIG. 6 illustrates a flowchart of a process of the central management apparatus when contents are uploaded in the sharing system according to an exemplary embodiment of the present disclosure;

FIG. 7 illustrates a flowchart of a process of the user device when contents are uploaded in the sharing system according to an exemplary embodiment of the present disclosure;

FIG. 8 illustrates a flowchart of a process of the central management apparatus when a content list is updated in the sharing system according to an exemplary embodiment of the present disclosure;

FIG. 9 illustrates a block diagram of the central management apparatus in the sharing system according to an exemplary embodiment of the present disclosure; and

FIG. 10 illustrates a block diagram of the user device in the sharing system according to an exemplary embodiment of the present disclosure.

Throughout the drawings, like reference numerals will be understood to refer to like parts, components and structures.

### DETAILED DESCRIPTION OF THE INVENTION

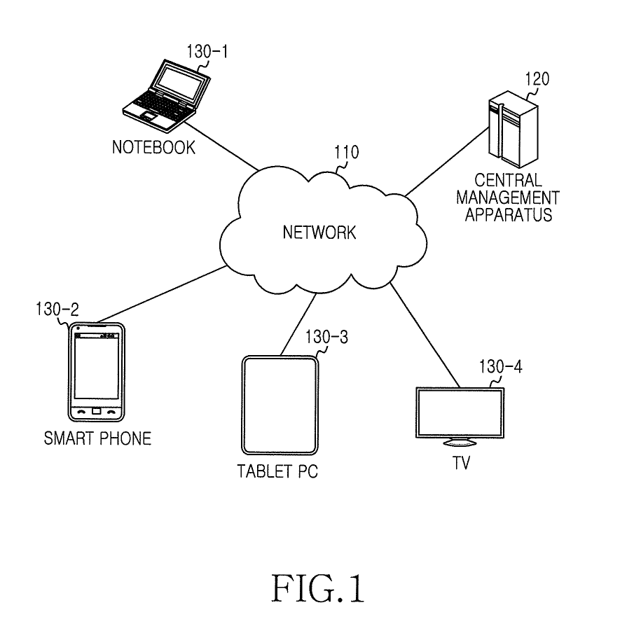

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of exemplary embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of exemplary embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a technique for ensuring privacy in a content sharing system, more specifically, for ensuring high privacy protection using account log-in and an additional policy when components of a network share their contents.

FIG. 1 illustrates a diagram of a sharing system according to an exemplary embodiment of the present disclosure.

As shown in FIG. 1, the sharing system according to an exemplary embodiment of the present disclosure includes a network 110, a central management apparatus 120, and a plurality of user devices 130-1 through 130-4.

The network 110 is used for communication between the central management apparatus 120 and the user devices 130-1 through 130-4. The network 110 can be wireless or wired. The network 110 can use a Wireless Local Area Network (WLAN). In this case, the network 110 can include at least one Access Point (AP), or adopt Wireless Fidelity-Direct (WiFi-D) technology without the AP. The network 110 can be established based on a short-range communication technique such as Bluetooth. According to an exemplary embodiment of the present disclosure, the network 110 can be a set of networks. For example, the network 110 can include part of the network in the home and an external network. For example, the external network can include Internet Protocol (IP) network. In this case, when even a user device outside the home can log into the central management apparatus 120 over the IP network, the user device outside the home and the user device inside the home can share their contents.

The central management apparatus 120 holds and manages every device accessing the network 110 and owner account information of the devices. The central management apparatus 120 retains latest content lists of the devices by updating content lists stored to the devices on the periodic basis or if necessary. Herein, the updating of the content list includes at least one of addition/deletion of the contents and sharing range change of the contents. In so doing, it is assumed that the owner of the content in the content list is the same as the owner of the device which updates the list. That is, to support the content sharing according to an exemplary embodiment of the present disclosure, the central management apparatus 120 holds information of the account of the family member, every device in the home, and all content stored to the device, and manages and controls the content sharing.

The central management apparatus 120 stores the content list. The content list also includes sharing setting information set by the owner of the content for all content in the list, which is categorized into fully shared, partially shared, and private. The fully shared accesses the corresponding content using the accounts of all the family members according to the content owner, the partially shared allows the access using only part of the accounts of the members (e.g., father or sister), and the private allows the access from only the account of the content owner. That is, the fully shared rarely limits the sharing range, and the partially shared and the private limit the sharing range. The partially shared partially limits the sharing range, and the private has no sharing range.

The central management apparatus 120 manages all of the contents from the updated content list of every device in the network. For the content sharing, when the account logging onto the central management apparatus 120 requests the content list in the network, the central management apparatus 120 provides a list including only the contents which are sharable through the corresponding account. The sharing range of a folder of the device can be set in the same manner as the content sharing setting. The partially shared folder or the private folder can be set to allow the access through password input.

The user devices 130-1 through 130-4 are personal portable devices such as notebook 130-1, smart phone 130-2, and tablet PC 130-3, and home appliances such as TV 130-4. The user devices 130-1 through 130-4 can access the network 110 and includes a storage means for storing the contents. The user devices 130-1 through 130-4 can download the content stored to other device via the central management apparatus 120, and upload the content to the central management apparatus 120. In some cases, some of the user devices 130-1 through 130-4 can support either the download or the upload. While the notebook 130-1, the smart phone 130-2, the tablet PC 130-3, and the TV 130-4 are depicted in FIG. 1, more user devices can be applied. Some of the user devices in FIG. 1 can be omitted or replaced with other user devices.

When the content sharing system of FIG. 1 is built inside the home, the content sharing system can be referred to as a smart home system. The central management apparatus 120 can be referred to as a Home Cloud Gateway (HCG).

A privacy management method when the contents are shared in the smart home system according to an exemplary embodiment of the present disclosure takes account of a case where the log-in account logging onto the central management apparatus intends to download the content stored to the device in the network, a case where the log-in account logging onto the central management apparatus intends to upload the content stored to the device used for the log-in, and a case where the device in the network intends to update the device's stored content list. Now, such cases are explained with examples.

The content download is described.

A particular account logs onto the central management apparatus through a particular device and then intends to download the partially shared or private content among the contents stored to the devices in the network including the central management apparatus. In this case, according to an exemplary embodiment of the present disclosure, the central management apparatus determines whether the owner account of the device used for the log-in falls within the content sharing range. Herein, the owner account within the sharing, range signifies that the account has the sharing rights; that is, has the right to share the corresponding content. When the owner account of the device used for the log-in does not fall within the content sharing range, the central management apparatus can take a measure such as warning output. By contrast, when the owner account of the device used for the log-in falls within the content sharing range, the central management apparatus determines whether the sharing range of the download folder of the device used for the log-in falls within the content sharing range. Herein, the folder sharing range within the content sharing range signifies that all of the accounts in the folder sharing range include the all the accounts in the content sharing range; that is, the content sharing range is wider than or equal to the folder sharing range. When the download folder sharing range does not fall within the content sharing range, the central management apparatus can take a measure such as warning output.

For example, it is assumed that, when the sharing network is built within the home, to see a girlfriend's photo pre-stored to the central management apparatus or other device in the home, the son logs onto the central management apparatus with the son's account using the notebook of the mother and downloads the photo of his girlfriend. When the girlfriend photo is private and the downloaded photo remains in the notebook of the mother, the son's privacy is invaded. Hence, to protect the privacy, the central management apparatus needs to take a measure for the privacy protection by determining whether the log-in account for the download-requested content falls within the sharing range of the corresponding, content and determining whether the owner account of the log-in device falls within the content sharing range.

For example, the measure can continue or abort the download according to the user's selection after the warning is output. In this case, the central management apparatus sends the warning inquiring, about the user's selection, and the user device receiving the warning displays a screen inquiring about the continuance/abortion of the download to the user and then sends a message notifying the user's selection result to the central management apparatus. When the user selects the continuation, the download is carried out. By contrast, when the user selects the abortion, the download is aborted.

Another example of the measure can output the warning for the log-out. When the user account logs out, the central management apparatus sends the warning inquiring about the user's selection and the user device receiving the warning displays a screen warning that the sharing range of the user device downloading the content is outside the content sharing range.

Yet another example of the measure can delete the corresponding content for the log-out. When the user account logs out, the user device deletes the downloaded content. In so doing, the central management apparatus sends the content deletion command and the user device can delete the content according to the content deletion command. Alternatively, the user device can delete the content according to a predefined procedure, without the content deletion command.

For example, it is assumed that the son downloads his girlfriend photo stored to the central management apparatus or other device in the home to his smart phone through the central management apparatus and then the sister uses the smart phone of the son when the sharing network is built within the home. In this case, when the sister can access the folder storing the girlfriend photo stored to the smart phone, the son's privacy can be invaded. Hence, the central management apparatus takes a measure for the privacy protection by determining whether the log-in account for the download-requested content falls within the sharing range of the corresponding content, determining whether the owner account of the log-in device falls within the corresponding content sharing range, and determining whether the download folder sharing range storing the downloaded content falls within the content sharing range.

An example of the measure can continue or abort the download according to the user's selection after the warning is output. In this case, the central management apparatus sends the warning inquiring about the user's selection, and the user device receiving the warning displays the screen inquiring about the continuance/abortion of the download to the user and then sends the message notifying the user's selection result to the central management apparatus. When the user selects the continuation, the download is carried out. By contrast, when the user selects the abortion, the download is aborted.

Another example of the measure can output the warning for the log-out. When the user account logs out, the central management apparatus sends the warning inquiring about the user's selection and the user device receiving the warning displays the screen warning that the sharing range of the user device downloading the content is outside the content sharing range.

Yet another example of the measure can output the warning for the log-out and delete the content according to the user selection. When the user account logs out, the central management apparatus sends the warning inquiring about the user's selection and the user device receiving the warning displays the screen warning that the sharing range of the user device downloading the content is outside the content sharing range and the screen inquiring about the content deletion. When the user selects the deletion, the user device deletes the downloaded content.

Still another example of the measure can delete the corresponding content for the log-out. When the user account logs out, the user device deletes the downloaded content. In so doing, the central management apparatus sends the content deletion command and the user device can delete the content according to the content deletion command. Alternatively, the user device can delete the content according to a predefined procedure, without the content deletion command.

A further example of the measure can change the download folder or generate a new download folder. In this case, the user device changes the download folder to other folder having the proper sharing range, or generates the new download folder of the proper sharing range. The central management apparatus can send a download folder change or generation command, and the user device can change or generate the folder according to the download folder change or generation command. Alternatively, the user device can change or generate the download folder in a predefined manner without the download folder change or generation command.

Another example of the content download is described.

When the contents are partially shared, before checking the owner account of the user device used for the log-in, the central management apparatus can inquire of the content owner account about whether to accept the sharing and proceed with the next operation only when receiving the acceptance.

For example, it is assumed that, when the sharing network is established in the home, the father, mother, and sister accounts can share a file of the mother recording family finances and the file sharing setting is changed to the sharing only through the father and mother accounts, which is not yet reflected to the central management apparatus. The sister may download the file and invade the mother's privacy. Hence, when the download-requested content is partially shared, the central management apparatus can provide additional privacy protection policy. That is, when the download of the partially shared content is requested, though the log-in account falls within the content sharing range, the central management apparatus can inquire of the representative device of the owner preset by the content owner about whether to accept the sharing and take a measure to allow the sharing after receiving the acceptance from the content owner.

The content upload is now explained.

A particular account logs onto the central management apparatus through a particular device and then intends to upload the content stored to the device to the central management apparatus. In this case, according to an exemplary embodiment of the present disclosure, the central management apparatus determines whether the central management apparatus's upload folder sharing range falls within the sharing range of the content to upload. When the upload folder sharing range does not falls within the sharing range of the content to upload, the central management apparatus takes a measure, for example, changes the upload folder to other folder of the proper sharing range or generates a new upload folder of the proper sharing range, and then proceeds with the uploading.

For example, it is assumed that, when the sharing network is established in the home, the son backs the contents such as photos and videos with his girlfriend up to the central management apparatus because of lack of the storage space of his home device. When the sharing range of the upload folder storing the uploaded content in the central management apparatus includes other family member unwanted by the son, the privacy invasion can occur. When a large amount of contents of different sharing ranges is backed up to the central management apparatus using auto back at the same time and stored to the upload folder of the different sharing range from the contents, the family member not set for the sharing can access the corresponding contents through the central management apparatus and thus the privacy invasion can occur. Hence, the central management apparatus needs to take a measure for the privacy protection by determining whether the sharing range of central management apparatus's upload folder for storing the uploaded contents falls within the content sharing range.

An example of the measure can continue or abort the uploading according to the user's selection after the warning is output. In this case, the central management apparatus sends the warning inquiring about the user's selection, and the user device receiving the warning displays a screen inquiring about the continuance/abortion of the uploading to the user and then sends a message notifying the user's selection result to the central management apparatus. When the user selects the continuation, the uploading is carried out. By contrast, when the user selects the abortion, the uploading is aborted.

Another example of the measure can change or generate the upload folder. In this case, the central management apparatus changes the upload folder to other folder of the proper sharing range, or generates a new upload folder of the proper upload folder.

The content list updating is explained.

A particular device intends to update the device's content list stored to the central management apparatus. In this case, according to an exemplary embodiment of the present disclosure, the central management apparatus determines whether the content list of other devices or other accounts pre-stored to the central management apparatus includes the same content with respect to the contents of the list. When the content list of the other devices or the other accounts includes the same content, the central management apparatus determines whether the sharing ranges of the contents are the same. When the sharing ranges are different, the central management apparatus resets the sharing range of the existing list and updates the target list with the same sharing range so that the contents can be shared only by the accounts set to the share the contents, in all the lists including the target list. When the central management apparatus resets the other content list or the update-requested content list is updated differently from the request because of the different sharing ranges, the central management apparatus notifies the corresponding device of the reset sharing, range and the updated sharing range different from the request.

For example, it is assumed that, when the sharing network is established in the home, the mother and the father store the file recording the family finances to their devices respectively, the father sets the file sharing range to the father, mother, and sister accounts and updates the content list to the central management apparatus through his device, and the mother sets the sharing range allowing only the father and the mother and then updates the content list. In this case, when the central management apparatus does not take any measure for the different sharing ranges of the same content, the sister can download the file stored to the father's device and accordingly the mother's privacy can be invaded. Hence, the central management apparatus needs to compare the contents of the updated content list with the content list of the other device and make the sharing range the same when the other device stores the same content. Examples of the measure can include the update abortion according to the user's selection after the warning is output, and the sharing range change of the corresponding content in every list by comparing the conflicting sharing ranges so that only the account falling within all of the sharing ranges can share the contents.

Hereafter, operations and structures of the central management apparatus and the user device are described in detail by referring to the drawings.

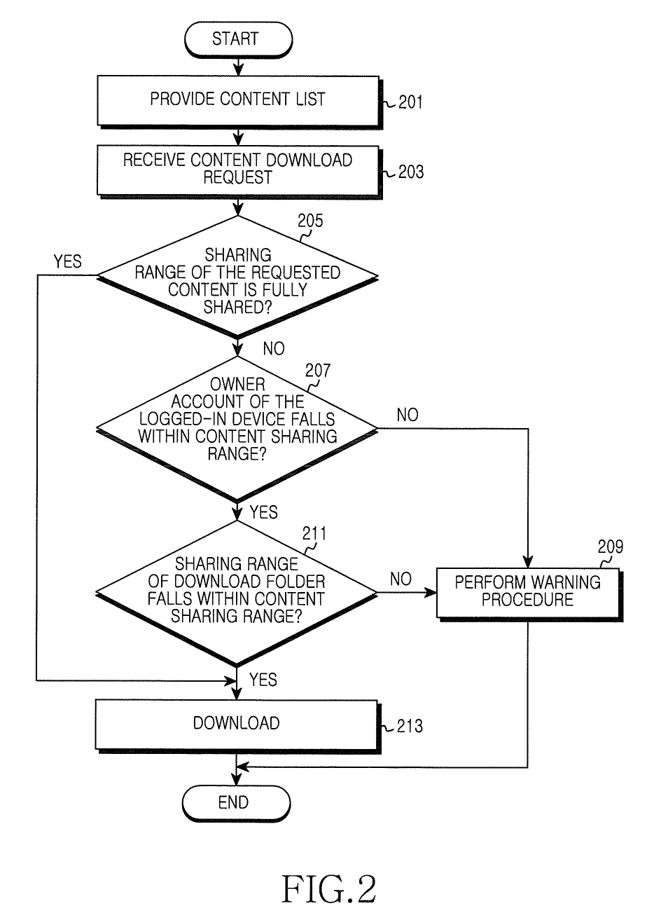

FIG. 2 illustrates a flowchart of a process of the central management apparatus for the content download in the sharing system according to an exemplary embodiment of the present disclosure.

Referring to FIG. 2, the central management apparatus provides the content list to the user in step 201. That is, when the user logs onto the central management apparatus through the user device and then requests the content list, the central management apparatus sends the content list to the user. In so doing, the user may be the same as or different from the owner of the user device. Herein, the content list can include the contents which include the user in the sharing range; that is, only the contents accessible by the user account. Alternatively, the content list can include the contents stored to all the devices accessing the network.

In step 203, the central management apparatus receives the content download request from the user device. That is, the central management apparatus receives a message requesting the content download from the user device. The content download request includes identification information of the user's intended content to download.

In step 205, the central management apparatus determines whether the sharing range of the requested content is fully shared. That is, the central management apparatus determines whether the requested content has the sharing range accessible by any account of the family member; that is, whether the sharing range of the content is not limited. When the sharing range of the requested content is fully shared, the central management apparatus goes to step 213.

When the sharing range of the requested content is not fully shared; that is, when the sharing range of the content is limited, the central management apparatus determines whether the owner account of the user device used for the log-in falls within the sharing range of the content in step 207. Namely, the owner of the user device can differ from the owner of the logged-in account. In this case, the central management apparatus inspects the owner account of the user device used for the log-in.

When the owner account of the user device does not fall within the sharing range of the content, the central management apparatus performs the waning procedure in step 209. The warning procedure follows a predefined manner. For example, the warning procedure sends a warning message to the user device. Contents in the warning include at least one of a reason of the warning, an inquiry about whether to carry out the downloading, and a content deletion command. The warning procedure can transmit the content according to the user's selection. After transmitting the content, the warning procedure can retransmit the warning for the log-out of the user account. Alternatively, after transmitting the content, the warning procedure can instruct to delete the corresponding content for the log-out of the user account. Alternatively, the warning procedure can delete the content according to the user's selection when the user account logs out. Alternatively, the warning procedure can send the warning, transmit the content without the user's selection, and then retransmit the warning when the user account logs out. Alternatively, the warning procedure can transmit the content without the warning and then send the warning when the user account logs out.

By contrast, when the owner account of the user device falls within the sharing range of the content, the central management apparatus determines whether the sharing range of the download folder falls within the content sharing range in step 211. That is, when the sharing range of the download folder is wider than the content sharing range, the unintended sharing can take place. In this regard, the central management apparatus inspects the sharing range of the download folder to store the content.

When the sharing range of the download folder does not fall within the content sharing range, the central management apparatus performs the waning procedure in step 209. The warning procedure follows the predefined manner. For example, the warning procedure sends the warning message to the user device. The contents in the warning include at least one of the reason of the warning, the inquiry about whether to carry out the downloading, and the content deletion command. The warning procedure can transmit the content according to the user's selection. After transmitting the content, the warning procedure can retransmit the warning for the log-out of the user account. Alternatively, after transmitting the content, the warning procedure can instruct to delete the corresponding content for the log-out of the user account. Alternatively, the warning procedure can send the warning, transmit the content without the user's selection, and then retransmit the warning when the user account logs out. Alternatively, the warning procedure can transmit the content without the warning and then send the warning when the user account logs out. The warning procedure can instruct to change the download folder to the other folder of the proper sharing range. Alternatively, the warning procedure can instruct to generate the new download folder of the proper sharing range.

By contrast, when the sharing range of the download folder falls within the content sharing range, the central management apparatus downloads the content in step 213. That is, the central management apparatus provides the content to the user device. Herein, the content provision indicates that not only the central management apparatus transmits the central management apparatus's stored content but also the central management apparatus controls the other device to transmit the content stored to the other device to the user device or relays the content. When the central management apparatus directly transmits the content, the central management apparatus can packetize the content and then transmit packets including the content.

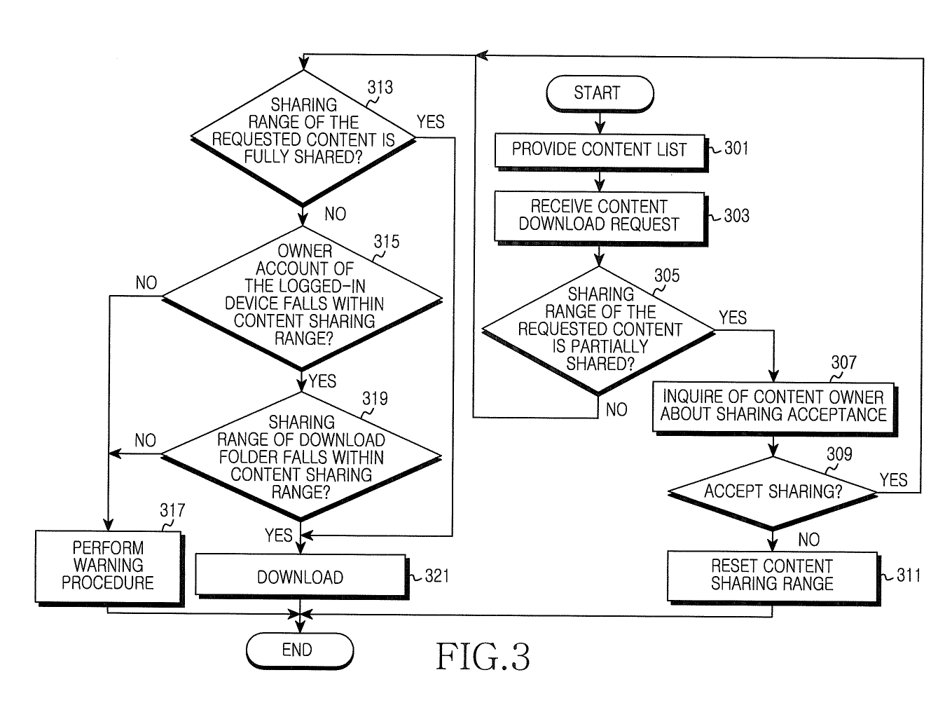

FIG. 3 illustrates a flowchart of a process of the central management apparatus for the content download in the sharing system according to another exemplary embodiment of the present disclosure.

Referring to FIG. 3, the central management apparatus provides the content list to the user in step 301. That is, when the user logs onto the central management apparatus through the user device and then requests the content list, the central management apparatus sends the content list to the user. Herein, the content list can include the contents which include the user in the sharing range; that is, only the contents accessible by the user account. Alternatively, the content list can include the contents stored to all the devices accessing the network.

In step 303, the central management apparatus receives the content download request from the user device. The content download request includes identification information of the user's intended content to download.

In step 305, the central management apparatus determines whether the sharing range of the requested content is partially shared. That is, the central management apparatus determines whether the content has the sharing range accessible only by the account of the designated family member. That is, the central management apparatus determines whether the sharing range of the content is partially limited.

When the sharing range of the content is partially shared, the central management apparatus inquires of the content owner about whether to accept the sharing in step 307. That is, the central management apparatus sends a message inquiring about the sharing acceptance, to the device of the content owner or the log-in device of the content owner account. The message includes the identification information of the download-requested content and identification information of the user account requesting the download. The change of the user having the access rights may not be reflected to the central management apparatus because of the partial sharing. In this regard, for the partially shared contents, the central management apparatus inquires of the content owner about whether to accept the sharing. Alternatively, when the user of the logged-in account is the same as the content owner, the central management apparatus can proceed to step 313, although the sharing range of the content is partially shared.

In step 309, the central management apparatus determines whether the sharing is accepted. That is, the central management apparatus receives a response message of the message inquiring about the sharing acceptance or rejection, and checks whether the response indicates the acceptance or the rejection.

When the sharing is rejected, the central management apparatus resets the sharing range of the content in step 311. That is, the central management apparatus removes the user requesting the download from the sharing range of the content access right. Alternatively, when the sharing is rejected, the central management apparatus can request to send a message for changing the sharing range to the content owner, and reset the content sharing range according to the message. Alternatively, the message for changing the sharing range can be part of the message for rejecting the sharing. Alternatively, the central management apparatus can request the content list updating to the content owner.

By contrast, when the sharing is accepted or when the content sharing range is not partially shared in step 305, the central management apparatus determines whether the sharing range of the requested content is fully shared in step 313. That is, the central management apparatus determines whether the requested content has the sharing range accessible by any account of the family member. When the sharing range of the requested content is fully shared, the central management apparatus goes to step 321.

When the sharing range of the requested content is not fully shared, the central management apparatus determines whether the owner account of the user device used for the log-in falls within the sharing range of the content in step 315. Namely, the owner of the user device can differ from the owner of the logged-in account. In this case, the central management apparatus inspects the owner account of the user device used for the log-in.

When the owner account of the user device does not fall within the sharing range of the content, the central management apparatus performs the waning procedure in step 317. The warning procedure follows the predefined manner. For example, the warning procedure sends the warning message to the user device. The contents in the warning include at least one of the reason of the warning, the inquiry about whether to carry out the downloading, and the content deletion command. The warning procedure can transmit the content according to the user's selection. After transmitting the content, the warning procedure can retransmit the warning for the log-out of the user account. Alternatively, after transmitting the content, the warning procedure can instruct to delete the corresponding content for the log-out of the user account. Alternatively, the warning procedure can send the warning, transmit the content without the user's selection, and then retransmit the warning when the user account logs out. Alternatively, the warning procedure can transmit the content without the warning and then send the warning when the user account logs out.

By contrast, when the owner account of the user device falls within the sharing range of the content, the central management apparatus determines whether the sharing range of the download folder falls within the content sharing range in step 319. That is, when the sharing range of the download folder is wider than the content sharing range, the unintended sharing can take place. In this regard, the central management apparatus inspects the sharing range of the download folder to store the content.

When the sharing range of the download folder does not falls within the content sharing range, the central management apparatus performs the waning procedure in step 317. The warning procedure follows the predefined manner. For example, the warning procedure sends the warning message to the user device. The contents in the warning include at least one of the reason of the warning, the inquiry about whether to carry out the downloading, and the content deletion command. The warning procedure can transmit the content according to the user's selection. After transmitting the content, the warning procedure can retransmit the warning for the log-out of the user account. Alternatively, after transmitting the content, the warning procedure can instruct to delete the corresponding content for the log-out of the user account. Alternatively, the warning procedure can send the warning, transmit the content without the user's selection, and then retransmit the warning when the user account logs out. Alternatively, the warning procedure can transmit the content without the warning and then send the warning when the user account logs out. The warning procedure can instruct to change the download folder to the other folder of the proper sharing range. Alternatively, the warning procedure can instruct to generate the new download folder of the proper sharing range.

By contrast, when the sharing range of the download folder falls within the content sharing range, the central management apparatus performs the content download in step 321. That is, the central management apparatus provides the content to the user device. Herein, the content provision indicates that not only the central management apparatus transmits the central management apparatus's stored content but also the central management apparatus controls the other device to transmit the content stored to the other device to the user device or relays the content. When the central management apparatus directly transmits the content, the central management apparatus can packetize the content and then transmit packets including the content.

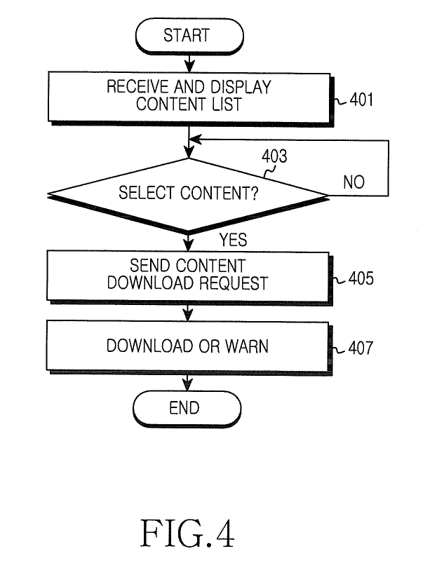

FIG. 4 illustrates a flowchart of a process of the user device for downloading contents in the sharing system according to an exemplary embodiment of the present disclosure.

Referring to FIG. 4, the user device receives the content list from the central management apparatus and displays the content list so that the user can perceive the content list in step 401. That is, the user device logs onto the central management apparatus with the user's account according to the user's manipulation, requests the content list; that is, sends the message requesting the content list, and receives the content list, which are not depicted in the drawing. Herein, the content list can include the contents including the user in the sharing range; that is, only the contents accessible by the user account. Alternatively, the content list can include the contents stored to all of the devices accessing the network.

In step 403, the user device determines whether the user selects at least one content to download. That is, the user device confirms the user's command input through an input means and confirms the selection corresponding to the command.

When the content is selected, the user device sends the download request of the selected content in step 405. In other words, the user device sends the message requesting to download the content, to the central management apparatus. In so doing, the download request includes identification information of the content to download; that is, the content selected by the user in step 403.

In step 407, the user device performs the download procedure or the warning procedure. The warning procedure can be conducted when the content sharing range does not include the owner of the user device, when the content sharing range does not include the sharing range of the download folder for storing the content, or when the content owner rejects the sharing. When the download procedure is conducted, the user device receives the content from the central management apparatus or the other device and stores the content to the download folder. When the warning procedure is conducted, the user device can perform at least one of the warning message reception, the warning display, the inquiring display about whether to proceed with the downloading, the content download, the content deletion command reception, the inquiry display about the content deletion, the download folder change command reception, the download folder generation command reception, the content deletion for the log-out, the download folder change, and the download folder generation.

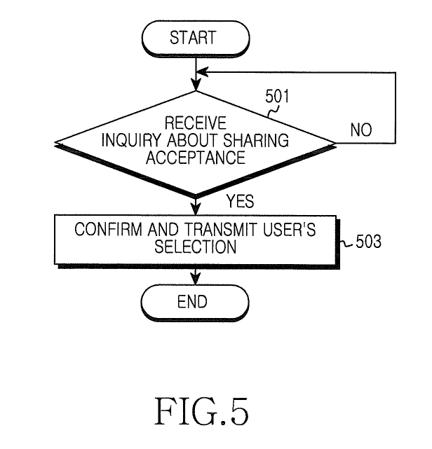

FIG. 5 illustrates a flowchart of a process of the user device for accepting or rejecting the downloaded content sharing in the sharing system according to an exemplary embodiment of the present disclosure.

Referring to FIG. 5, the user device determines whether the inquiry about the content sharing acceptance or rejection is received in step 501. That is, the user device determines whether the message inquiring about whether to accept the sharing is received. The user device is either the user device of the content owner or the user device of the logged-in account of the content owner.

In step 503, the user device confirms the user's selection and notifies the selection result. That is, the user device confirms the user's command input through the input means and confirms the selection corresponding to the command. The user device sends the message notifying the user's selection; that is, the acceptance or the rejection to the central management apparatus.

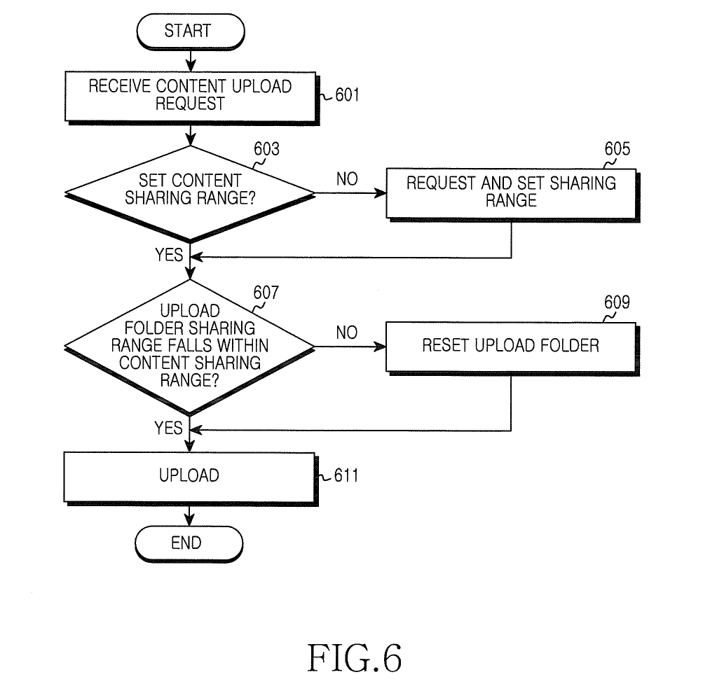

FIG. 6 illustrates a flowchart of a process of the central management apparatus for the content upload in the sharing system according to an exemplary embodiment of the present disclosure.

Referring to FIG. 6, the central management apparatus receives the content upload request in step 601. In other words, the central management apparatus receives the message requesting the content upload from the user device. The content upload request includes identification information of the content to upload.

In step 603, the central management apparatus determines whether the content sharing range is set. That is, the central management apparatus stores information of the sharing ranges of the contents. Accordingly, the central management apparatus determines whether the information of the content sharing range is stored.

When the content sharing range is not set, the central management apparatus requests the content sharing range to the user device and sets the content sharing range according to the response received from the user device in step 605. That is, the central management apparatus sends a message requesting to provide the content sharing range and receives a message informing of the sharing range. Alternatively, when the content upload request includes the content sharing range, the request of the content sharing range can be omitted. Next, the central management apparatus goes to step 607.

By contrast, when the content sharing range is set, the central management apparatus determines whether the upload folder sharing range falls within the content sharing range in step 607. That is, when the sharing range of the upload folder is wider than the content sharing range, the unintended sharing can take place. In this regard, the central management apparatus inspects the sharing range of the upload folder for storing the content.

When the upload folder sharing range does not fall within the content sharing range; that is, when the sharing range of the upload folder is wider than the content sharing range, the central management apparatus resets the upload folder in step 609. For example, the central management apparatus can reset the upload folder by changing or newly generating the upload folder. Alternatively, the central management apparatus can send the warning inquiring about the uploading. Next, the central management apparatus proceeds to step 611. Notably, when sending the warning inquiring about the uploading and receiving the response indicating the upload rejection, the central management apparatus finishes this process.

By contrast, when the upload folder sharing range falls within the content sharing range, the central management apparatus performs the content upload in step 611. That is, the central management apparatus receives and stores the content to the upload folder. Although it is not depicted here, the central management apparatus can update the content list.

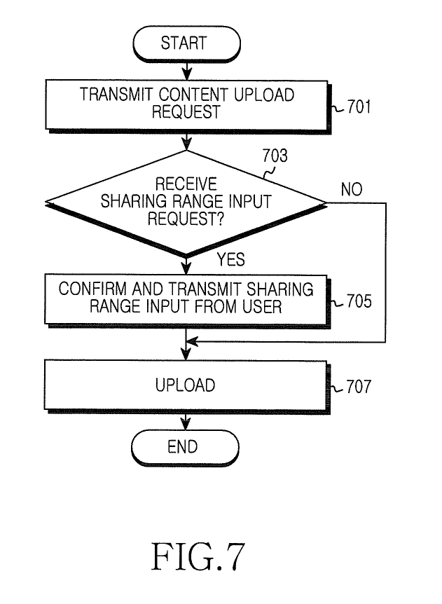

FIG. 7 illustrates a flowchart of a process of the user device for the content upload in the sharing system according to an exemplary embodiment of the present disclosure.

Referring to FIG. 7, the user device transmits the content upload request to the central management apparatus in step 701. That is, the user device logs onto the central management apparatus with the user's account according to the user's manipulation, identifies the upload command and the content to upload according to the user's manipulation, and sends the message requesting the content upload, which are not depicted in the drawing. Herein, the content upload request includes the identification information of the content to upload.

In step 703, the user device determines whether the content sharing range input request is received. That is, the user device determines whether the message requesting to input the sharing range of the content to upload is received. The sharing range input request can be received when the central management apparatus does not set the content sharing range. When the content upload request includes the content sharing range, the sharing range input request may not be received, although the content sharing, range is not set in the central management apparatus.

Upon receiving the sharing range input request, the user device confirms the sharing range input by the user and transmits the sharing range to the central management apparatus in step 705. That is, the user device displays the screen requesting to input the sharing range so that the user can perceive it, and confirms the user's input.

In step 707, the user device uploads the content. That is, the user device transmits the content to the central management apparatus. In so doing, the user device can packetize the content and transmit packets including the content. Alternatively, before transmitting the content, the warning inquiring about the uploading can be received because the upload folder sharing range does not fall within the content sharing range. In this case, the user device displays the screen inquiring about the uploading and sends the message notifying the user's selection. When the user rejects the uploading, the user device may not transmit the content.

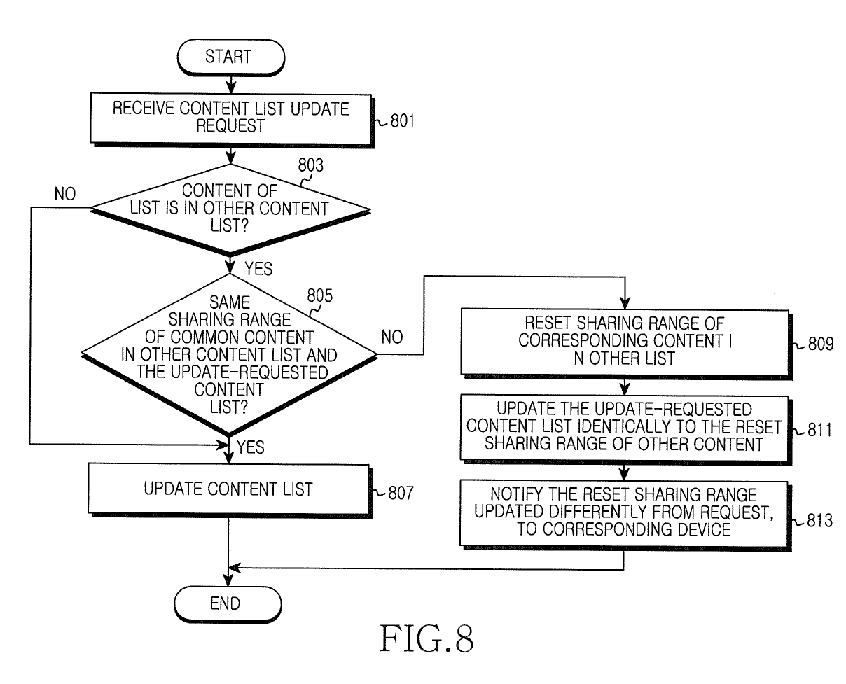

FIG. 8 illustrates a flowchart of a process of the central management apparatus for the content list update in the sharing system according to an exemplary embodiment of the present disclosure.

Referring to FIG. 8, the central management apparatus receives the content list update request in step 801. Namely, the central management apparatus receives the message requesting to update the content list, from the user device. The content list update request requests at least one of the content addition, the content deletion, and the content sharing range change.

In step 803, the central management apparatus determines whether at least one other content list stored to the central management apparatus includes the contents of the update-requested content list. That is, the central management apparatus determines whether there is other content list including the common content with the update-requested content list. When there is no other content list including the common content, the central management apparatus goes to step 807.

By contrast, when another content list including the common content exists, the central management apparatus determines whether the sharing ranges of the common contents of the other content list and the update-requested content list are the same in step 805. When the sharing ranges are the same, the central management apparatus goes to step 807. When the sharing ranges are not the same, the central management apparatus goes to step 809. In so doing, when part of the sharing ranges are the same and part of the sharing ranges are different, step 807 is applied to the content of the same sharing range and step 809 is applied to the content of the different sharing range independently.

When the sharing ranges are the same, the central management apparatus updates the content list according to the received content list update request in step 807. That is, according to the content list update request received in step 801, the central management apparatus updates the sharing range of at least one content.

By contrast, when the sharing ranges are not the same, the central management apparatus resets the sharing range of the common content in the at least one other content list including the common content in step 809. The sharing range of the common content is reset to share at least one account accessible in all of the update-requested content list and the content lists including the common content. When there is no account accessible in all of the content lists, all the content lists can set the content to the private content.

In step 811, the central management apparatus updates the update-requested content list identically to the reset sharing range of the at least one other content list. That is, the central management apparatus equally applies the reset sharing range of the at least one other content list to the update-requested content list.

In step 813, the central management apparatus notifies the reset sharing range to the corresponding device. Further, when the update-requested content list is updated differently from the request, the central management apparatus notifies the user device of the sharing range updated differently from the request. Thus, the sharing range between the central management apparatus and the user devices can be synchronized.

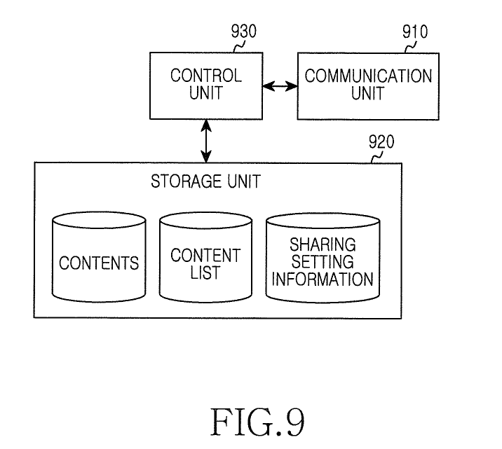

FIG. 9 illustrates a block diagram of the central management apparatus in the sharing system according to an exemplary embodiment of the present disclosure.

As shown in FIG. 9, the central management apparatus includes a communication unit 910, a storage unit 920, and a control unit 930.

The communication unit 910 provides an interface for accessing the network. The communication unit 910 provides a wireless or wired interface. For example, the communication unit 910 can generate and analyze a radio signal according to the WLAN standard. The storage unit 920 stores a basic program and an application program for the operations of the central management apparatus. The storage unit 920 stores the contents, the content list, and the sharing setting information of the users accessible to the network. The storage unit 920 provides the stored data according to a request of the control unit 930.

The control unit 930 controls the functions of the central management apparatus. For example, the control unit 930 processes the log-in and the log-out of the user account. The control unit 930 processes the content download, the content upload, and the content list update. The control unit 930 maintains and manages the contents, the content list, and the sharing setting information stored to the storage unit 920. In particular, the control unit 930 controls the central management apparatus to operate as shown in FIGS. 2, 3, 6 and 8.

For example, when receiving the content download request from the user account through the user device, the control unit 930 determines whether to carry out the download by considering at least one of the sharing range of the download-requested content, the content access right of the user account, the content access right of the user account of the user device owner, the download folder sharing range, and the sharing acceptance or rejection of the content owner. More specifically, when the content sharing range is limited, when the content sharing range includes the user account, when the content sharing range includes the owner account of the user device, and when the content sharing range includes the download folder sharing range, the control unit 930 determines to proceed with the download. In so doing, when the content sharing range is partially limited, the control unit 930 sends the message inquiring about the sharing acceptance or rejection to the content owner device or the logged-in device of the user account of the content owner through the communication unit 910. By contrast, when the content sharing range does not include the owner account of the user device or when the content sharing range does not include the download folder sharing range, the control unit 930 performs the warning procedure. Herein, the warning procedure includes at least one of the warning message transmission, the determination whether to perform the download according to the user selection, the warning message transmission when the user account logs out, the content deletion command transmission when the user account logs out, the content deletion according to the user selection when the user account logs out, the download folder change command transmission to the folder of the sharing range within the content sharing range, and the download folder generation command transmission of the sharing range within the content sharing range.

When the content upload request is received from the user account through the user device, the control unit 930 determines whether to carry out the upload by considering at least one of the sharing range of the upload-requested content and the upload folder sharing range. More specifically, when the upload folder sharing range falls within the content sharing range, the control unit 930 determines to proceed with the upload. In so doing, when not storing the content sharing range, the control unit 930 sends the message requesting to provide the content sharing range through the communication unit 910.

When receiving the content list update request from the user account through the user device, the control unit 930 sets the sharing range of at least one content of the content list by considering at least one of the sharing range of at least one content of the update-requested content list and the sharing range of the at least one content set in the other content list. More specifically, when at least one content of the update-requested content list is not included in the other content list, the control unit 930 updates the content list according to the content list update request. When the sharing range of the at least one content of the update-requested content list is the same as that of the at least one content of the other content list, the control unit 930 updates the content list according to the content list update request. By contrast, when the sharing range of the at least one content of the update-requested content list is not the same as that of the at least one content of the other content list, the control unit 930 sets the sharing range of the at least one content of the update-requested content list and the other content list so as to share only at least one account accessible in both of the update-requested content list and the other content list.

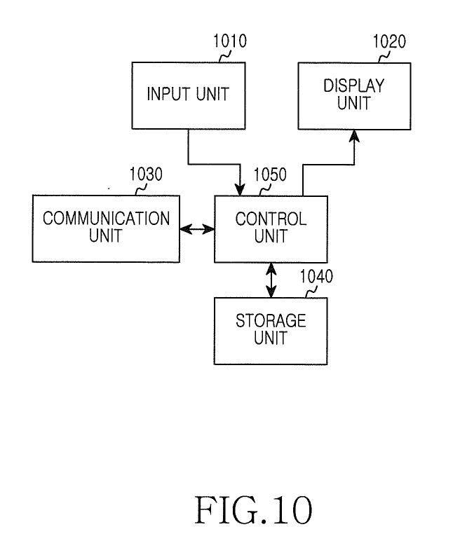

FIG. 10 illustrates a block diagram of the user device in the sharing system according to an exemplary embodiment of the present disclosure.

As shown in FIG. 10, the user device includes an input unit 1010, a display unit 1020, a communication unit 1030, a storage unit 1040, and a control unit 1050.

The input unit 1010 recognizes the input generated by the user and provides information corresponding to the input to the control unit 1050. That is, the input unit 1010 processes the user's input through a keyboard, a keypad, a touch screen, a touch pad, a mouse, and a specific function button. The display unit 1020 displays status information generating during the operations of the user device, and numbers, characters, and images according to the execution of the application. That is, the display unit 1020 presents image data provided from the control unit 1050 for visual recognition. For example, the display unit 1020 can use a Liquid Crystal Display (LCD), a Light-Emitting Diode (LED), an Organic Light-Emitting Diode (OLED), and so on. The input unit 1010 and the display unit 1020 can be implemented as a single block. For example, the input unit 1010 and the display unit 1020 can be implemented using a touch screen.

The communication 1030 provides an interface for accessing the network. The communication 1030 provides a wireless or wired interface. For example, the communication unit 1030 can generate and analyze a radio signal according to the wireless LAN standard. The storage unit 1040 stores a basic program for the operations of the user device, an application program, and data such as user contents. The storage unit 1040 provides the stored data according to a request of the control unit 1050.

The control unit 1050 controls the functions of the user device. For example, the control unit 1050 processes the log-in and the log-out of the user account. The control unit 1050 processes the content play, the content download, the content upload, and the content list update according to the user's command through the input unit 1010. In particular, the control unit 1050 controls the user device to operate as shown in FIGS. 4, 5 and 7.

Embodiments of the present invention according to the claims and description in the specification can be realized in the form of hardware, software or a combination of hardware and software.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As set forth above, it is possible to prevent the privacy invasion in the environment where several family members share the contents by comprehensively considering not only the account of the logged-in user but also the account corresponding the owner of the device used for the log-in and the sharing range of the folder used for the download and the upload.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents.

What is claimed is:

1. A method for managing content in a content sharing system, the method comprising:
receiving, from a first device associated with a first account, a request to download content; and
determining whether to allow the download based on at least one of a sharing range of the content requested, a content access right of the first account, a content access right of an owner account of the first device, a sharing range of a download folder, or a sharing acceptance or rejection of an owner of the content.

2. The method of claim 1, wherein determining whether allow the download comprises:
when the sharing range of the content is limited, the first account falls within the sharing range of the content, the owner account of the first device falls within the sharing range of the content, and the sharing range of the download folder falls within the sharing range of the content, determining to allow the download; and
when the first account and the owner account of the first device fall within the sharing range of the content, sending the content to the first device.

3. The method of claim 2, further comprising:
when the owner account of the first device does not fall within the sharing range of the content, performing a warning procedure,
wherein the warning procedure comprises at least one of a warning message transmission, a determination whether to perform the download according to a user selection, a warning message transmission when the first account is logged out, content deletion according to the user selection when the first account is logged out, or content deletion command transmission when the first account is logged out.

4. The method of claim 2, further comprising:
when the sharing range of the download folder does not fall within the sharing range of the content, performing a warning procedure,
wherein the warning procedure comprises at least one of a warning message transmission, a determination whether to perform the download according to a user selection, a warning message transmission when the first account is logged out, content deletion according to a user selection when the first account is logged out, content deletion command transmission when the first account is logged out, a download folder change command transmission to a folder of the sharing range falling within the sharing range of the content, or a download folder generation command transmission of the sharing range falling within the sharing range of the content.

5. The method of claim 1, further comprising:
when the sharing range of the content is partially limited, transmitting a message inquiring about the sharing acceptance or rejection, to a device of the content owner or a device of a logged-in content owner account.

6. A method for managing content in a content sharing system, the method comprising:
receiving, from a first device associated with a first account, a request to upload content; and
determining whether to allow the upload based on at least one of a sharing range of the content requested to be uploaded or a sharing range of an upload folder.

7. The method of claim 6, further comprising:
when not storing the sharing range of the content, transmitting a message including a request to provide the sharing range of the content.

8. The method of claim 6, wherein determining whether to allow the upload comprises:
when the sharing range of the upload folder falls within the sharing range of the content, determining to allow the upload.

9. The method of claim 8, further comprising:
when the sharing range of the upload folder does not fall within the sharing range of the content, performing a warning procedure,
wherein the warning procedure comprises at least one of a warning message transmission, a determination whether to perform the upload according to a user selection, an upload folder change to a folder within the sharing range of the content, or generation of an upload folder within the sharing range of the content.

10. A method for managing content in a content sharing system, the method comprising:
receiving a request to update a content list from a first device associated with a first account; and
setting a sharing range of at least one content in the content list based on at least one of a sharing range of at least one other content in the content list requested to be updated or a sharing range of corresponding content in another content list.

11. The method of claim 10, wherein setting the sharing range of the at least one content of the content list comprises:
when the at least one content is not in the other content list, updating the content list according to the request to update the content list.

12. The method of claim 10, wherein setting the sharing range of the at least one content of the content list comprises:
when the sharing range of the at least one content is the same as the sharing range of the corresponding content in the other content list, updating the content list according to the request to update the content list.

13. The method of claim 10, wherein setting the sharing range of the at least one content of the content list comprises:
when the sharing range of the at least one content is not the same as the sharing range of the corresponding content of the other content list, setting the sharing range of the at least one content in the content list requested to be updated and the other content list so as to share only at least one account accessible in both of the content list requested to be updated and the other content list.

14. An electronic device for managing content in a content sharing system, the device comprising:
a communication unit configured to receive, from a first device associated with a first account, a request to download content; and
a control unit configured to determine whether to allow download based on at least one of a sharing range of the content requested, a content access right of the first account, a content access right of an owner account of the first device, a sharing range of a download folder, or a sharing acceptance or rejection of an owner of the content.

15. The device of claim 14, wherein, when the sharing range of the content is limited, the first account falls within the sharing range of the content, the owner account of the first device falls within the sharing range of the content, and the sharing range of the download folder falls within the sharing range of the content, the control unit is configured to determine to allow the download.

16. The device of claim 14, wherein, when the sharing range of the content is partially limited, the control unit is configured to transmit a message inquiring about the sharing acceptance or rejection, to a device of the content owner or a device of a logged-in content owner account.

17. An electronic device for managing content in a content sharing system, the device comprising:
a communication unit configured to receive, from a first device associated with a first account, a request to upload content; and
a control unit configured to determine whether to allow the upload based on at least one of a sharing range of the content requested to be uploaded or a sharing range of an upload folder.

18. The device of claim 17, wherein, when not storing the sharing range of the content, the control unit is configured to transmit a message including a request to provide the sharing range of the content.

19. An electronic device for managing content in a content sharing system, the device comprising:
a communication unit configured to receive a request to update a content list from a first device associated with a first account; and
a control unit configured to set a sharing range of at least one content in the content list based on at least one of a sharing range of at least one other content in the content list requested to be updated or a sharing range of corresponding content in another content list.

20. The device of claim 19, wherein, when the at least one content is not in the other content list, the control unit is configured to update the content list according to the request to update the content.
